(19) United States
(12) Patent Application Publication
(10) Pub. No.: US 2007/0271731 A1
(43) Pub. Date: Nov. 29, 2007

(54) Door stop and bumper assembly

(76) Inventor: Edward A. Fuller, Orchard Lake, MI (US)

Correspondence Address: Bernard J. Cantor, 5685 Forman Drive, Bloomfield Hills, MI, 48301-1154, US

(21) Appl. No.: 11/441,956

(22) Filed: May 26, 2006

(51) Int. Cl. E05F 5/02

(52) U.S. Cl. 16/82

(57) ABSTRACT

A wedge shaped door stop used for wedging beneath a lower edge of a swinging door to prevent the door from moving, is removably stored within a resilient socket which is adhesively attached to the surface of the door which is adjacent to a wall surface when the door is swung open. The socket is shaped to closely receive the stop when the stop is not used. The assembled stop and socket or, alternatively the socket itself form a resilient bumper arranged between the door and the wall surface to prevent direct contact of the door against the wall when the door is swung open.

### BACKGROUND OF INVENTION

In order to immobilize a swinging door in its open position, it is conventional to utilize a wedge-shaped stop which is jammed beneath the lower edge of the door and against the floor underneath the door. Conventional wedge-shaped door stops are commonly made of a resilient, rubbery type of plastic material which can be pushed into the gap between the lower edge of the swinging door and the floor beneath it. Thus, the wedge tends to frictionally grip the door and the floor and prevent the door from swinging.

In addition, it is conventional to provide bumpers of various constructions on a swinging door so that when the door is swung toward an adjacent wall, the bumper prevents direct contact between the door, and particularly the door knob, against the wall. The bumper thus prevents damage to the wall by the door, particularly when the door is swung open forcefully.

Where wedge-shaped stops are utilized, a common problem is that these stops tend to be lost or moved away from the door when they are not in use. Hence, they are frequently lost or at least they are not apparently available when needed since they are not necessarily kept close to the door.

Where bumpers are utilized on swinging doors, these are commonly formed of a spindle having an end formed with a threaded screw-like portion for attaching to the lower corner portion of a door and with the opposite end having a resilient tip for engaging an adjacent wall surface. These conventional bumpers may be bent or damaged by the polishing or cleaning machinery commonly used in cleaning floors when the adjacent floor surfaces are mopped or polished or scrubbed.

Thus, it would be desirable to have a system whereby the desirable wedge-shaped stop is readily available, that is, clearly visibly available, for use when desired and similarly to have a simplified damage resistant system providing a bumper between the swinging door and the adjacent wall. Such a construction would simplify the use and storage of the stops, making them clearly and readily available and simultaneously to make available along with the stops, bumpers which are less likely to be damaged, are readily available and easily installed.

Thus, the invention herein is concerned with an assembly of a conventional wedge-shaped stop and a socket which holds the stop upon the lower edge of the door when the stop is not used and simultaneously serves as a bumper either with or without the stop. This will be described in more detail below.

### SUMMARY OF INVENTION

This invention contemplates forming a receptacle made of thin, relatively flexible or resilient sheet plastic material that is bent into a socket of a shape corresponding to the wedge shape of a conventional door stop. Thus, the socket of the receptacle is formed with an open top and a downwardly narrowing cavity within which a conventional wedge-shaped door stop may be inserted downwardly for temporary storage. The edges of the socket are formed provided with laterally extending flanges which are joined to a backing sheet which closes the rear of the socket. The backing sheet is preferably provided with pressure-sensitive adhesive coating upon its rear, exposed surface so that the receptacle may be manually applied to a conventional door surface by simply pressing it against the surface and relying upon the adhesive to hold the socket in position.

The socket projects away from the surface of the door towards and against the adjacent surface of a wall when the door is swung open to provide a resilient bumper. That is, the socket, by itself, acts as a somewhat resilient bumper or alternatively, the socket and the stop form a bumper when the wedge stop is inserted within the socket so that the assembly forms the resilient bumper.

Summarizing, it is an objective of this invention to provide a simplified assembly of a socket that can be attached to the lower surface of a door and which can receive a conventional wedge-shaped door stop that is utilized to immobilize the door. The assembly also forms a bumper between the door and adjacent wall.

Another object of the invention is to provide an extremely simple, inexpensive socket for holding a conventional wedge-shaped door stop, which socket can be manually applied to a door and utilized without the necessity of any mechanical fastening devices or any skilled workers by simply adhering the socket to the door with an adhesive. For this purpose, the adhesive may be a conventional pressure-sensitive adhesive having a cover sheet which is peeled off by the user when applying the adhesive-coated backing of the socket against the door.

These and other objects and advantages of this invention will become apparent upon reading the following description, of which the attached drawings form a part.

### DESCRIPTION OF DRAWINGS

The drawings described herein are for illustration purposes only and are not intended to limit the scope of the present disclosure in any way.

FIG. 1 is a perspective view illustrating the door stop-bumper assembly secured upon the lower edge corner of a swinging door.

FIG. 2 is a side view of the receptacle secured to the lower edge of a door with the wedge inserted between the lower edge of the door and the floor and the socket-receptacle engaged against an adjacent wall.

FIG. 3 is a perspective disassembled view showing the stop above and ready to be inserted downwardly into the socket.

FIG. 4 is a rear, perspective view illustrating an adhesive band applied upon the rear of the backing sheet and with a cover sheet over the adhesive being partially torn away.

FIG. 5 is a cross-sectional view taken of the receptacle along arrows 5-5 of FIG. 1.

FIG. 6 is a view similar to FIG. 5 but illustrating the stop, in cross-section, inserted within the socket.

FIG. 7 is a perspective view of a modified socket having bent flanges formed on the side edges of the sloped, forward wall of the socket.

FIG. 8 illustrates a modified stop.

FIG. 9 illustrates a second modified stop.

### DETAILED DESCRIPTION

The following description is exemplary in nature and is not intended to limit the present disclosure, application, or uses.

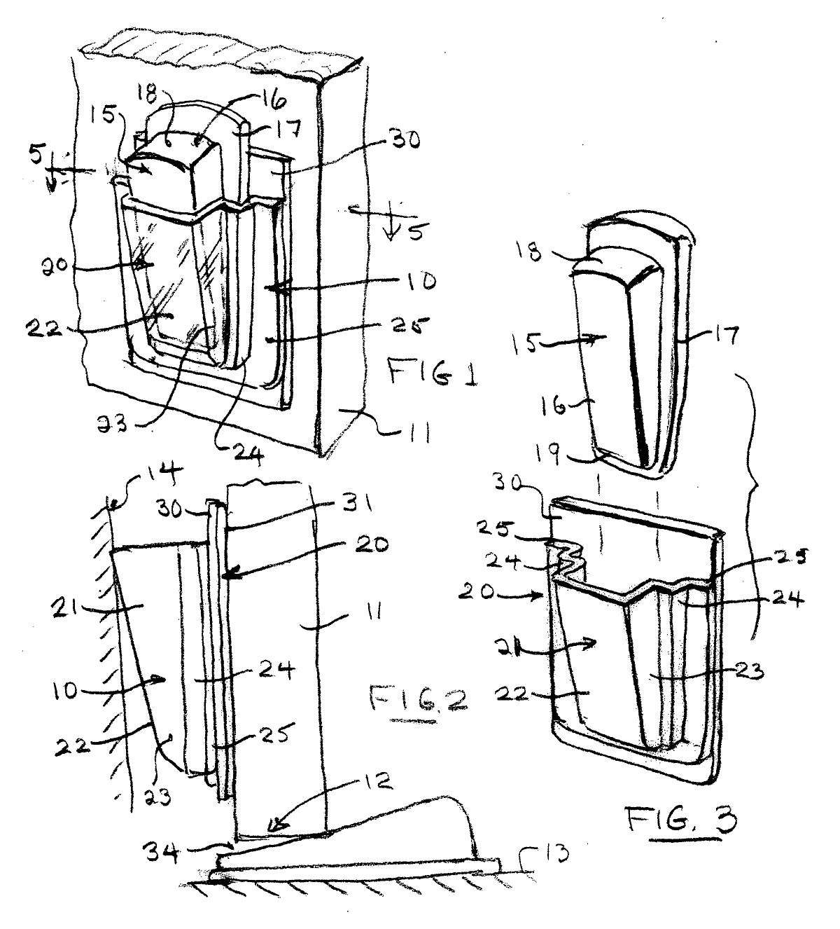

As illustrated in FIG. 1, the door stop and bumper assembly 10 is attached to the lower corner of a typical swinging door 11. The door has a lower edge 12 which is spaced a short distance above the floor 13. Also, the door is close to an adjacent wall 14 when it is swung into an open position as illustrated schematically in FIG. 2.

The wedge-shaped door stop 15 (see FIG. 3) is provided with a wedge-shaped body 16 which may be made of a suitable plastic, and preferably a resilient plastic, material. The stop includes an integral flange 17 which surrounds the wedge-shaped body portion. The wedge has a wider upper end 18 which tapers to the narrow end 19.

As shown in FIG. 3, the stop is inserted in the receptacle 20 or, more specifically, the socket 21 from within the receptacle. The socket 21 is made by bending a thin sheet of flexible or relatively resilient, plastic material to form a front wall 22 which tapers or slopes downwardly and inwardly. Integral sidewalls 23 are joined to the front wall and these, in turn, are provided with a channel portion 24. The sidewall channel portions terminate in lateral side flanges 25. The wall portions defining the channels may resiliently flex or bend towards and away from the door under impact for partially absorbing impact forces.

A backing sheet 30 is secured to the flanges 25, preferably by a suitable adhesive material.

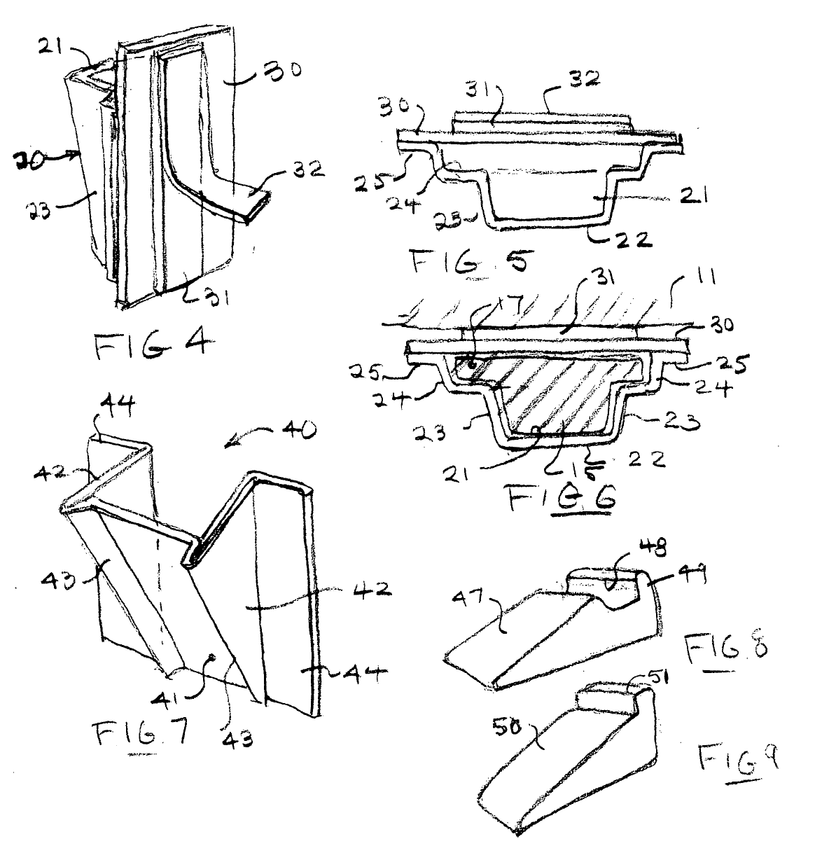

A strip of adhesive material 31 is applied to the rear face of the backing sheet 30 (see FIG. 4). That adhesive is preferably of any suitable, commercially available pressure-sensitive type. Normally, before use, the adhesive is covered with a conventional cover sheet 32. Just before applying the receptacle to the door, the cover sheet 32 is pulled away, as indicated schematically in FIG. 4 of the drawings.

In operation, when the door is to be immobilized, that is, swung open and kept in that open position, the stop is physically jammed into the gap 34 between the lower edge of the door 11 and the floor 13, as shown in FIG. 2. The frictional engagement of the stop with the lower edge of the door and the floor holds the door against swinging.

When the stop is not needed, it may be placed in the socket, as illustrated in FIG. 1. When the door is swung wide open, the door or the door knob may engage the adjacent wall which is close to the open door (see FIG. 2). Thus, the socket itself will act as a bumper between the door and wall. If the resilient stop is arranged within the socket, the stop forms part of the bumper. Preferably, the socket itself forms a resilient bumper. The bent channels 24 in the formed sidewalls of the socket increase the resiliency or springiness of the sidewalls 23 of the socket. When the stop is inserted, the bumper resiliency and its shock absorbancy are increased, particularly in instances where the door is slammed hard against the adjacent wall so that there is considerable force or pressure.

The channels 24 receive the conventional flange 17 found on typical resilient wedge-shaped stops, which increases the absorption of the forces of such pressure and helps to protect the door and the wall against damage. Most damage in those instances occurs because the conventional handle or knob on the door bangs into the wall and causes a mark or a hole in the wall. Thus, the socket construction and/or the socket-stop assembly reduce the possibility of damage to the wall.

A modified socket 40 is contemplated wherein the socket is formed with forward beads or flanges 43 on the junctures of the front wall 41 and sidewalls 42. The walls are bent to form the extending beads which extend a short distance outwardly or forwardly of the front wall 41. The laterally bent side flanges 44 formed on the sidewalls 42 may be adhesively attached to the backing wall (not shown). The backing wall may be adhesively attached to the doors. The beads 43 contact against a wall, when the door is swung open, and tend to absorb forces that are due to the force of slamming of the door against the wall.

It is also contemplated to provide the wedge-shaped stop with a projection or handle-like formation for simplifying and facilitating manual grasping of the stop when it is pulled out from beneath the door or pulled out of the socket. Thus, FIG. 8 illustrates a modification of a stop 47 having a groove 48 formed near its wider end. The placement of the groove forms a grip or projection 49 on the stop. The projection can be manually engaged either by hand or by the toe of a shoe, to move the wedge.

A second modified wedge 50, illustrated in FIG. 9, includes an integral projection 51 along the wider edge of the stop for engaging the stop by hand or by foot.

This invention may be further developed in accordance with the attached claims. Thus, having fully described at one operative, preferred embodiment of this invention, it is desired that the foregoing description be read as being merely illustrative of a preferred construction and not in a limiting sense. Hence, without limiting the claim construction or operation or method of using the invention, the invention herein is claimed as follows:

What is claimed is:

1. A door stop and door bumper assembly comprising a stop member and a receptacle for temporarily holding the stop member upon a swinging door;
said stop member being shaped to engage the lower edge of a swinging door for temporarily holding the door against movement;
said receptacle being formed with a thin wall, plastic material, having an open top socket shaped to temporarily closely receive and hold the stop member when it is inserted into the socket through the open top; and
said receptacle being adapted to be adhesively secured to the surface of a door, which surface is normally in close proximity to a wall surface when the door is swung into an open position;
whereby the socket forms a bumper between the door and a wall surface when the door is moved towards said wall surface and the stop member may be manually removed from the socket for use in holding the door against swinging movement or for insertion in the socket for storage and for providing a bumper in cooperation with the socket when the receptacle bearing surface of the door is moved towards the wall surface.

2. A door stop and door bumper assembly including said socket being formed of a resilient plastic material.

3. A door stop and door bumper assembly as defined in claim 1, and wherein said stop member is formed in an elongated, wedge shape and the socket is correspondingly wedge-shaped and of a size to snugly receive at least a portion of the wedge member when the wedge member is inserted in the socket through the open top thereof.

4. A construction as defined in claim 3, and said stop member being formed of a resilient material for fitting beneath and gripping against, the lower edge of a door and in contact with the floor which is beneath the door, for frictionally holding the door against movement; and the stop member and the socket act jointly as a bumper between the door and an adjacent wall surface to avoid direct contact between the door and the wall surface.

5. A door stop and door bumper assembly as defined in claim 4, and including said socket being made of a thin, flexible, sheet of plastic material bent into a wedge-like shape, corresponding to the shape of the stop member and having a flat back wall for engaging against a door surface, a front wall inclined downwardly and rearwardly, that is, towards the back wall, and integral wedge-shaped sidewalls and being of a size to closely receive at least the lower portion of the wedge member with the wedge member being arranged so that a portion of its wider end extends upwardly and outwardly of the socket; and
flanges integral with and extending laterally, that is, parallel to the plane of the door surface upon which the receptacle is mounted, from the respective sides of the socket, with said flanges being connected to said back member.

6. A door stop and bumper assembly as defined in claim 5, and including pressure-sensitive adhesive applied upon the back wall for attachment to the door surface for thereby mounting the receptacle upon the surface of the door; and said socket extending forwardly of the door, that is, towards the adjacent wall surface, to form a bumper when the wedge member is removed from the socket and with the socket and wedge member together forming a bumper when the wedge member is inserted within the socket.

7. A door stop and door bumper assembly as defined in claim 4, and said wedge member having an edge portion formed on its upper, wider end, to provide a projection which may be manually engaged for moving the wedge member into and out of the socket and from beneath the lower edge of the door manually.

8. A door stop and door bumper assembly comprising:
a wedge-shaped stop and a receptacle having a socket for temporarily holding the stop upon a door;
said stop member being shaped and sized as a wedge to engage between the lower edge of a swinging door and the ground surface beneath the door for temporarily holding the door against swinging motion;
said receptacle being formed of a thin wall, flexible sheet bent into a socket having an open top and shaped to correspond to the size and shape of the narrow portion of the wedge-shaped stop for receiving and holding the stop within the socket;
said socket having a front wall arranged at an angle relative to the door and integral sidewalls tapered to form, together with the front wall, the wedge shaped corresponding to the shape of the stop;
said receptacle having a back wall and pressure-sensitive adhesive on the exposed rear surface of the back wall for adhesively attaching the surface of the receptacle to the surface of the door;
said receptacle being adapted to be secured to the surface of the door which is adjacent to a wall surface when the door is swung into an open position so that the socket forms a bumper between the door and the wall surface alternatively by itself or when the stop is inserted within the socket.

9. A door stop receptacle for removably attaching a wedge-shaped door stop upon a swinging door and for acting as a bumper between the door and an adjacent wall surface, said receptacle comprising:
an open top socket shaped to receive and hold a conventional wedge-shaped door stop inserted into the socket through the open top of the socket;
a backing formed on the socket for arranging the socket in contact with a surface of the door;
an adhesive material applied upon the backing for adhesively securing the backing upon said door surface with the socket extending away from said door surface for receiving a wedge-shaped stop;
whereby the socket may be applied upon the surface of a door which is adjacent a wall surface when the door is swung into an open position; and the socket, when contacting said wall, acts as a bumper between the door and the wall surface to prevent contact between the door and the wall surface.

10. A door stop receptacle as defined in claim 9, and including said socket being formed of a thin sheet of flexible, resilient plastic material bent into the shape of the stop for closely receiving and removably holding the stop.

11. A door stop receptacle as defined in claim 9, and said stop having a downwardly tapered front wall and integral downwardly tapered sidewalls to form a wedge shape which closely corresponds to the shape of the wedge stop when it is inserted downwardly into the socket through the open top of the socket, with at least the wider upper portion of the wedge extending above the socket.

12. A construction as defined in claim 10, and including integral flanges formed on the edges of the sidewalls, and said backing being formed of a sheet secured to the flanges and forming a back wall for the socket;
and a mechanical fastener for securing the back wall and the flanges to the door.

13. A construction as defined in claim 11, and said fastener being formed of a pressure-sensitive adhesive applied upon said back wall for adhering the socket to a door surface.

14. A construction as defined in claim 13, and said socket being shorter in height than the wedge-shaped stop when the stop is arranged vertically so that the socket tapers inwardly and downwardly from its open top towards the back wall for receiving a stop whose length, in the vertical direction, is greater than the vertical length of the socket so that the wide portion of the wedge stop extends upwardly out of the open end of the socket;
whereby the stop may be manually engaged for removing the stop upwardly from the socket and wherein the stop portion may engage the wall surface when the stop is held within the socket so that the socket and stop act as a bumper between the door and the adjacent wall surface.

15. A construction as defined in claim 14, and including a bumper normally inserted for storage purposes within the socket and manually removable therefrom for acting as a stop for immobilizing the door, with the wider portion of the wedge shape of the bumper extending upwardly out of the socket and having a projection formed thereon for facilitating manual engagement of the stop for removing it from the socket and/or from beneath the door, as required.

16. A construction as defined in claim 14, and said socket including laterally outwardly extending channels formed on the edges of the sidewalls of the socket; and arranged for receiving corresponding flanges formed on the side edges of a conventional wedge stop;
whereby the channels will facilitate holding a stop having side flanges when the stop is inserted within the socket and, in addition, the material defining the channels resiliently move towards and away from the door when the socket acts as a bumper against the adjacent wall surface when the door is swung against said wall.

17. A construction as defined in claim 16, and including a wedge-shaped stop inserted within the socket and being formed of a resiliently-yieldable material under pressure and impact so that the combined stop and socket together form a resilient bumper between the door and the adjacent wall when the door is swung toward the wall.
